(19) United States
(12) Patent Application Publication
(10) Pub. No.: US 2025/0063365 A1
(43) Pub. Date: Feb. 20, 2025

(54) MODULAR EDGE NETWORK SECURITY

(71) Applicant: Adveon Security Technologies, Inc., Edina, MN (US)

(72) Inventors: Eric Ong, Edina, MN (US); Qiren Que, Colorado Springs, CO (US)

(21) Appl. No.: 18/808,704

(22) Filed: Aug. 19, 2024

Related U.S. Application Data
(60) Provisional application No. 63/520,563, filed on Aug. 18, 2023.

(51) Int. Cl. H04W 12/121

(52) U.S. Cl. CPC H04W 12/121

(57) ABSTRACT

Systems and methods for monitoring network communications of low-level devices and sensors in an industrial control system (ICS) environment. A cloud-native application containerization platform allows for security visibility in the lower OT levels of the Purdue model, including by network traffic inspection in an active intrusion prevention system (IPS) mode or a passive intrusion detection system (IDS) mode.

### RELATED APPLICATION

This application claims priority to U.S. Provisional Application No. 63/520,563, titled “Modular Edge Network Security Appliance (MENSA) system for Operational Technology (OT) Environment,” filed Aug. 18, 2023, which is herein incorporated by reference in its entirety.

### TECHNICAL FIELD

Embodiments relate to the field of modular edge network security appliances (MENSA) for operational technology (OT) environments. More particularly, embodiments facilitate security visibility of industrial components, such as industrial control systems (ICS) and supervisory control and data acquisition (SCADA) systems, using cloud-native technology.

### BACKGROUND

The foundation of smart manufacturing requires organization, technology, and processes to work in concurrency and synergy to boost productivity. To achieve an adequate level of real-time harmonization, convergences of OT/IT networks become necessary. OT devices, such as ICS, Internet of Things (IoT), or specialized industrial IoT (IIoT), and building automation systems (BAS), are often resource-constrained and limited in computing power. These devices can lack the minimal technical capability to execute Information Technology (IT) host-based security capabilities. Resource constraints and limited computing power impact the tolerance of OT devices (e.g., programmable logical controllers (PLCs), remote terminal units (RTUs)), to withstand real-time interrogation during active vulnerability scanning. Indiscriminative active scans are known to cause performance degradation and even crashes and/or reboots.

In addition to gaps for security tools with OT devices, a fast-intensifying threat landscape has emerged. For example, advanced sophisticated threat actors can identify persistent vulnerabilities of process devices within an ICS environment. Failure to protect such vulnerabilities can have catastrophic effects in industrial settings and infrastructure systems leading to process interruption, product adulteration, and even health risks for workers who need to operate in stringent synergy with robots. Any accident can provoke significant human harm, losses in revenues, damage to brand reputation, and furthermore, the leakage of proprietary, production line data, such as trade secrets, can lead to loss of competitive advantages over competitors. Consequently, the aforementioned security concerns are becoming a substantial problem that requires a new type of network security solution specialized for the OT environment.

IT environments may include network security devices to implement intrusion prevention systems (IPS) or intrusion detection systems (IDS). Conventional applications of these two types of single-purpose security appliances are costly to acquire, time-consuming to set up, and require a team of specialized experts to operationalize. Moreover, existing solutions lock clients into deploying solutions specific to a proprietary platform. These factors limit the interoperability and budgetary optimization opportunities for security monitoring in ICS environments.

Therefore, there is a need for systems and methods that provide improved security visibility for OT devices.

### SUMMARY

Embodiments described or otherwise contemplated herein substantially meet the aforementioned needs of the industry. Embodiments described herein include systems and methods for security monitoring.

Through the utilization of a cloud-native application containerization platform, embodiments provide security visibility. For example, embodiments can provide security visibility in the lower OT levels (0-2) of the Purdue Enterprise Reference Architecture (“Purdue Model”). System architecture designs allow network traffic inspection with additional network detection and response (NDR) capabilities in an active IPS mode (e.g., an inline mode) and/or a passive IDS mode (e.g., an offline mode). In embodiments, provided passive network scanning capabilities allow for asset inventory of the low-layer devices in the ICS environment with high interoperability, low cost, and high applicability. Embodiments can be implemented with containerized applications or non-containerized applications. For example, security monitor systems of the present disclosure can be implemented as micro virtual machines capable of running a wide variety of applications.

In an embodiment, systems and methods implement cloud-native application containerization with a portable, extensible platform that manages containerized workloads and services. Such embodiments may be implemented, for example without a need for software to be installed on an endpoint and without additional restrictions on any hardware platform (e.g., process devices in the ICS environment).

In a feature and advantage of embodiments, systems can be implemented on physical or virtual infrastructures. More particularly, because of the particular worker node implementations relatively between devices and their respective control systems, embodiments are platform-agnostic.

In a feature and advantage of embodiments, NDR capabilities include a combination of non-signature-based analytical techniques such as machine learning to detect suspicious network activity via AI-power threat analysis. NDR capabilities facilitate proactive detection of anomalous or malicious traffic and threats that other security tools may miss. Detection of security events (e.g., a malware threat) can allow the security monitor system to automatically take a security action or prompt a user (e.g., an engineering team) to respond to these threats. For example, an AI module of the security monitor system can employ a feedback loop for refinement of security action recommendations. For example, an AI module of the security monitor system can leverage machine learning to classify anomalous traffic.

In a feature and advantage of embodiments, systems are configured for a zero-trust security framework. A zero-trust network security model assumes that every entity, transaction, and identity is untrusted until trust is established and maintained. In one example, embodiments configured for a zero-trust framework implement micro segmentation, which divides a network (e.g., the ICS network) into smaller, distinct security segments, for example, down to the individual workload or application level. Unlike traditional security models that assume everything inside an organization's network is trustworthy, zero trust network security models assume that threats can exist both inside and outside the network. This approach can improve the ability of the security monitoring system to detect security events within a previously impacted system (e.g., where malware may be dormant).

In an embodiment, a security monitoring system for monitoring low-level network communications of an industrial control environment comprises: an input/output module configured to: receive a signal from a process device associated with the industrial control environment, convert the signal into operational data that can be processed by a programmable logic controller (PLC); and a worker node configured to: intercept the operational data using a switch, decode the operational data based on a library of PLC supported protocols, and send the decoded operational data over a wireless network interface; and a gateway node configured to: receive the decoded operational data via the wireless network interface, and respond to a security threat in the decoded operational data.

In an embodiment, a method for monitoring low-level network communications of an industrial control environment comprises receiving a signal from a process device associated with the industrial control environment; converting the signal into operational data that can be processed by a programmable logic controller (PLC); intercepting the operational data using a switch; decoding the operational data based on a library of PLC supported protocols; and sending the decoded operational data over a wireless network interface; and responding to a security threat in the decoded operational data.

In an embodiment, a system for monitoring low-level network communications of an industrial control environment, comprises: at least one visibility node or relay node positioned on a communication channel between a process device and a control system, configured to: capture a stream of control system packets from the process device, decode the control system packets, preprocess the decoded control system packets to determine a subset of the decoded control system packets, and pack the subset of the decoded control system packets into a transfer protocol, the transfer protocol being different than a protocol of the stream of control system.

### BRIEF DESCRIPTION OF THE DRAWINGS

Subject matter hereof may be more completely understood in consideration of the following detailed description of various embodiments in connection with the accompanying figures, in which:

FIG. 1 is a block diagram of a system for security monitoring, according to an embodiment.

FIG. 2 is a system diagram of an inline mode modular edge network security appliance (MENSA) system deployed in an industrial control system (ICS) environment, according to an embodiment.

FIG. 3 is a process flow diagram of a method of inline mode operation for a system for security monitoring, according to an embodiment.

FIG. 4 is a system diagram of an offline mode modular edge network security appliance MENSA system deployed in an ICS environment, according to an embodiment.

FIG. 5 is a process flow diagram of a method of offline mode operation for a system for security monitoring, according to an embodiment.

FIG. 6 is a process flow diagram of a method of network analyzer operation for a system for security monitoring, according to an embodiment.

FIG. 7 is a flowchart of a method of security monitoring, according to an embodiment.

FIG. 8 is an operational flow diagram of a method for decoding operational data, according to an embodiment.

FIG. 9 is a system diagram of a mixed mode modular edge network security appliance MENSA system deployed in an ICS environment, according to an embodiment.

FIG. 10 is a system diagram of an inline mode MENSA system deployment with redundancy deployed in an ICS environment, according to an embodiment.

FIG. 11 is a system diagram of a highly available MENSA system deployment including a vehicle, according to an embodiment.

FIG. 12 is a flowchart of a method for security monitoring, according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

Hierarchical model ICS security is designed to address the unique security needs of ICS environments, which often differ significantly from those of traditional IT networks. These models help in organizing and managing the security measures required to protect ICS assets, networks, and data. The hierarchical approach divides the ICS security architecture into different layers, each with specific functions and security controls. In some implementations, the following levels (e.g., layers) can be used:
Level 0, the lowest level layer, can be referred to as a field devices layer. Level 0 generally includes the field devices (e.g., process devices) that interact directly with the physical environment. For example, process devices can include sensors, actuators, valves, climate control, pumps, motors, and the like.
Level 1 can be referred to as a process control layer. Level 1 encompasses the real-time control systems that manage the industrial processes. For example, control systems can include programmable logic controllers (PLCs), remote terminal units (RTUs), and distributed control systems (DCS).
Level 2 can be referred to as a local supervisory layer for monitoring and supervisory control for a single process. For example, level 2 systems can include an (HMI),
Level 3 can be referred to as a control network layer. Level 3 can include networks and systems that directly manage and control an industrial process. For example, level 3 systems can include control servers, engineering workstations, and data historians.
Level 4 can be referred to as an enterprise layer, which can be the highest level of the hierarchy that encompasses the organization's wider IT infrastructure, such as email servers, data centers, and administrative systems.

The Purdue Model is one example of a hierarchical model for ICS security used in an OT environment. The Purdue Model provides a structured approach to categorizing and securing various levels of an industrial network. The Purdue Model includes five levels, each representing a different aspect of the industrial process. Namely, the levels include:
Level 0. Field devices for the physical process.
Level 1. Local controllers for automated controls of a process.
Level 2. Local supervisory for monitoring and supervisory control for a single process.
Level 3. Site-wide supervisory for monitoring and supervisory and operation support.
Level 3.5 Plant/Site-Level demilitarized zone (DMZ), separating enterprise IT from air-gapped (e.g. a network security measure employed on one or more computers to ensure that a secure computer network is physically isolated from unsecured networks) OT.
Level 4. Business networks for business users at local sites.
Level 5. Enterprise networks for corporate-level services supporting business units.

The level-based segmentation is meant to separate and secure the physical processes, sensors, supervisory controls, operations, and logistics of the OT environment. For example, factories can implement computer-integrated manufacturing environments according to the Purdue Model for data flows that result in highly integrated and automated businesses, which streamline productivity. Based on the automation and isolation needs of the factory process, the Purdue model can define the standard for building an ICS network architecture in a way that supports OT security, thereby separating the layers of the network to maintain a hierarchical flow of data between layers.

Embodiments described herein are configured to provide security visibility into lower-levels of the OT environment. For example, security monitoring systems referred to as modular edge network security appliances (MENSA) are specially configured to provide security visibility into lower-level (0-2) OT devices below OT/IT DMZ (e.g., Purdue model level 3.5). Exemplary system architectures described herein can use cloud-native application containerization with a portable, extensible platform managing containerized workloads and services. In such architectures, no software needs to be installed on an endpoint and no additional restrictions are required on any hardware platform.

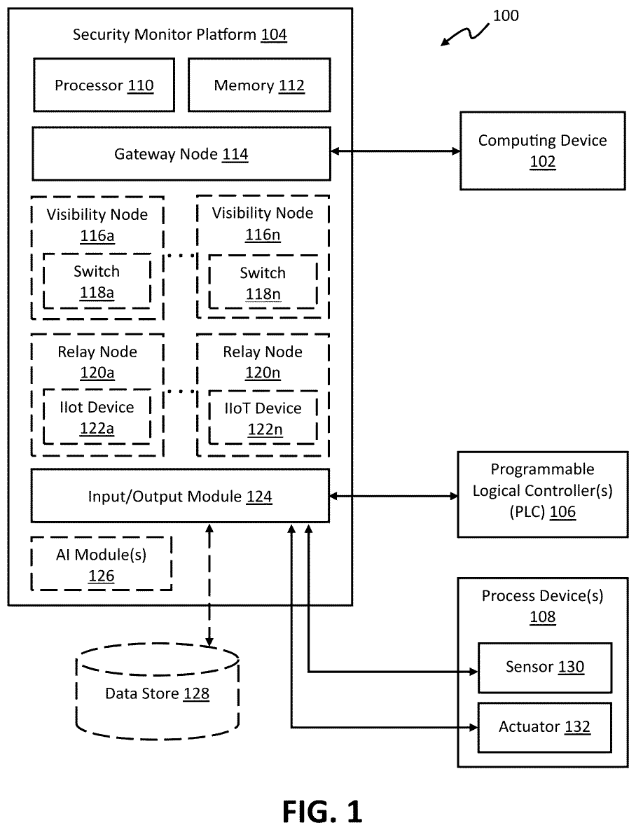

Referring to FIG. 1, a block diagram of a security monitor system 100 for monitoring (e.g., actively or passively monitoring) network communications of low-level IT/OT devices and sensors in the ICS environment is depicted, according to an embodiment. System 100 can be a MENSA system. In embodiments, as described and depicted herein, “MENSA” is used with reference to a given security monitor system embodiment. System 100 generally comprises a computing device 102, a security monitor platform 104, a programmable logic controller (PLC) 106, and a process device 108.

Computing device 102 comprises an electronic device in communication with system 100. In particular, system 100 can provide security visibility in the lower OT levels, for example, to provide intrusion prevention system (IPS) and/or intrusion detection system (IDS) capabilities to computing device 102. In an example, computing device 102 can be desktop computer, a laptop computer, tablet, mobile computing device, server, workstation, or Internet-of-things (IoT) device, among other electronic devices. Though depicted as protecting a single computing device, system 100 can, in other embodiments, include a plurality of computing devices 102, such as a networked system of devices. In embodiments, computing device 102 can be utilized by a user to scan a network and monitor asset inventory of low-layer devices, such as process device 108, in an ICS environment.

Security monitor platform 104 generally includes a processor 110, a memory 112, a gateway (e.g., master) node 114, worker node(s), an Input/Output (I/O) module 124, and optionally an AI module 126. In some implementations, there can be two types of worker nodes, visibility node(s) 116a, 116n and relay node(s) 120a, 120n. Though visibility node(s) 116a, 116n and relay node(s) 120a, 120n are depicted in the same figure for ease of illustration, the different types of worker nodes can be selected and used based on the architecture of security monitor platform 104. For example, in one aspect, system 100 implements only visibility node(s). In another aspect, system 100 implements only relay node(s). In another aspect, system 100 implements both visibility node(s) and relay node(s).

In an embodiment, processor 110 comprises a programmable device that accepts digital data as input, is configured to process the input according to instructions or algorithms, and provides results as outputs. Memory 112 is operably coupled to processor 110 and can comprise volatile or non-volatile memory as required by processor 110 to not only provide space to execute the instructions or algorithms, but to provide the space to store the instructions themselves.

In some embodiments, security monitor platform 104 is implemented with one of the following architectures: inline mode, offline mode, or mixed mode. The inline mode system includes gateway node 114 and one or more visibility nodes 116. The offline mode system includes gateway node 114 and one or more relay nodes 120 each connecting to a switch with a Switch Port Analyzer (SPAN) feature via an associated industrial Internet of Things (IIoT) device 122. In an embodiment, SPAN is a switch specific tool that copies Ethernet frames passing through switch ports and sends such frames out to a specific port. The mixed-mode architecture is a mixture of the inline mode and offline mode. The mixed-mode implementation includes gateway node 114, one or more visibility nodes 116, and one or more relay nodes 120 each connecting to a switch with a SPAN feature via an IIoT device 122.

Gateway node 114 is a hosted service, for example, that can be implemented with an existing level 3 host or a dedicated host, and a pod in the container system. The pod includes an application container. For example, the application container can be initiated via a container service and can be isolated using operating system-level virtualization. The application container communicates with visibility nodes 116 and IIoTs using a wireless network interface. Gateway node 114 can utilize the application container to receive the pre-processed network packets that are sent from visibility nodes 116 and IIoTs at the wireless network interface. In some implementations, each connection of gateway node 114 is used to receive the pre-processed network communications that are detected by a (e.g., one) visibility node or a (e.g., one) relay node.

A (e.g., each) visibility node 116 includes a switch 118. Switch 118 is a MENSA-managed network switch connecting I/O module 124 and PLC 106 in the ICS environment. Switch 118 can include an application container group (pod) in the container system. The pod includes a containerized network analyzer (CNA) application. The containerized network analyzer can be initiated via a container service and isolated, for example, using operating system-level virtualization. The containerized network analyzer captures network traffic by utilizing packet capture libraries to directly intercept and collect packets from the network interfaces. The containerized network analyzer decodes the captured network traffic by utilizing a list of libraries that support different protocols used by PLCs 106. The containerized network analyzer pre-processes the decoded network traffic. In one aspect, because the traffic is mainly between PLC 106 and other ICS devices, usually these have very small traffic flow. Accordingly, preprocessing of meta data (i.e. header) and selective payload data on demand (restriction to certain size) can prevent over-utilization of network bandwidth.

The containerized network analyzer sends the pre-processed decoded network traffic to gateway node 114 through a wireless network interface (e.g., WiFi, RAN). The I/O module 124 interfaces directly with sensors 130 and actuators 132 of process devices 108, converting analog or digital signals into data that PLC 106 can process. In some embodiments, switch 118 can collect all the traffic between process devices 108 (e.g., sensors 130 and/or actuators 132) and PLCs 106.

A (e.g., each) relay node 120 includes an IIoT device 122 that connects to a switch with a SPAN feature. The switch connects the I/O module 124 and PLC 106 in the ICS environment. The IIoT device 122 includes a pod in the container system. The pod includes a containerized network analyzer application. In one example, a pod is an encapsulation of an application composed of multiple co-located containers that are tightly coupled and need to share resources. In this case, the pod is a packaged environment for the network analyzer.

The containerized network analyzer can be initiated via a container service and, for example, isolated using operating system-level virtualization. The switch can utilize a SPAN port feature to create copies of network traffic. The containerized network analyzer captures network traffic by utilizing packet capture libraries to directly intercept and collect packets from the network interfaces. In one aspect, SPAN implements port mirroring or port monitoring and selects network traffic for analysis by a network analyzer. Because SPAN replicates traffic flows passing through selected ports, the data structure will be same as normal network protocol.

The containerized network analyzer decodes the captured network traffic by utilizing a list of libraries that support different protocols used by PLCs 106. The containerized network analyzer pre-processes the decoded network traffic and sends it to gateway node 114 through a wireless network interface. The I/O Module 124 interfaces directly with sensors 130 and actuators 132 of process devices 108, converting analog or digital signals into data that PLC 106 can process. In some embodiments, the IIoT device 122 can collect all the traffic copies between the process devices 108 (e.g., sensor 130 and/or actuator 132) and PLCs 106. In some implementations, since the network interface of the IIoT device 122 only collects copies of the traffic such that IIoT device 122 cannot interrupt or affect the original network communication.

Advantageously, a containerized network analyzer leverages the portability, efficiency, scalability of a containerized application as well as isolation in standardized packaging and consistent environments. In another embodiment, a container security platform can be implemented to protect the containerized application workload (e.g., NeuVector).

Accordingly, the respective network analyzers implemented by, for example, visibility node 116 and/or relay node 120 are configured for network traffic inspection as well as network traffic decoding and optionally, further encoding.

Gateway node 114 and I/O module 124 support input/output capabilities of security monitor platform 104. In an embodiment, gateway node 114 can provide an interface, such as a graphical user interface, configured to display related event topic fields and schemas and receive user input to computing device 102.

Gateway node 114 and I/O module 124 can include graphical or text-based interfaces. In an embodiment, gateway node 114 and/or I/O module 124 generate monitoring dashboards (e.g., reporting tools and analytics capabilities) to track the performance, efficiency, and compliance of process devices 108.

In an embodiment, I/O module 124 integrates with other systems and/or applications in the ICS environment, for example, to access data, trigger events, and exchange information. I/O module 124 can allow for interception and interpretation of data captured by one or more process devices 108. In an embodiment, I/O module 124 can be integrated into a worker node, such as a visibility node or a switch (e.g. communicatively coupled to a relay node). In an embodiment, I/O module 124 can be external to security monitor platform 104.

Optional AI module 126 is configured to utilize AI models to improve security visibility and anomaly detection. For example, AI module 126 can monitor the implementation of security protocols and log the details to improve system 100 effectiveness. Process metrics of process device 108 output can allow for automated improvement and optimization of security monitory platform 104 according to an embodiment.

In an example, properties associated with a malicious activity profile can be updated for future detection. In particular, AI module 126 can implement a feedback loop where the outcomes of an anomalous event (e.g., security threat, firmware update) are used to refine and improve security protocol effectiveness. For instance, if an operational reading is frequently detected in certain conditions representing a malicious attack, AI module 126 can learn to associate the applicability of the operational reading with specific malicious activity profiles.

In another example, reinforcement learning can be used to implement a reinforcement learning model where AI module 126 determines a recommended security action (e.g. isolation of process device(s) 108) based on rewards received for historical action responses (e.g., that were indicated as successful by a user). Over time, the model can optimize security action suggestions for various scenarios and properties, effectively learning from past actions.

In FIG. 1, AI module(s) 126 are depicted at the platform level for ease of illustration. AI module 126 can be implemented wholly on visibility node 116 or wholly on relay node 120, or portions of the ML model can be implemented at the platform level and portions on the respective worker node.

Embodiments of security monitor platform 104 described herein include various components (e.g., gateway node 114, visibility node(s) 116, relay node(s) 120, I/O module 124, optional AI module 126), each of which is constructed, programmed, configured, or otherwise adapted, to autonomously carry out a function or set of functions. The term component as used herein is defined as a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that adapt the component to implement the particular functionality, which (while being executed) transform the microprocessor system into a special-purpose device. A component can also be implemented as a combination of the two, with certain functions facilitated by hardware alone, and other functions facilitated by a combination of hardware and software. In certain implementations, at least a portion, and in some cases, all, of a component can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the component using multitasking, multithreading, distributed (e.g., cluster, peer-peer, cloud, etc.) processing where appropriate, or other such techniques.

A (e.g., each) component can be realized in a variety of physically realizable configurations and should generally not be limited to any particular implementation exemplified herein, unless such limitations are expressly identified. In addition, a component can itself be composed of sub-components, each of which can be regarded as a component in its own right. Moreover, in the embodiments described herein, each of the various components corresponds to a defined functionality; however, it should be understood that in other contemplated embodiments, each functionality can be distributed to more than one component. Likewise, in other contemplated embodiments, multiple defined functionalities can be implemented by a single component that performs those multiple functions, possibly alongside other functions, or distributed differently among a set of components than specifically illustrated in the examples herein.

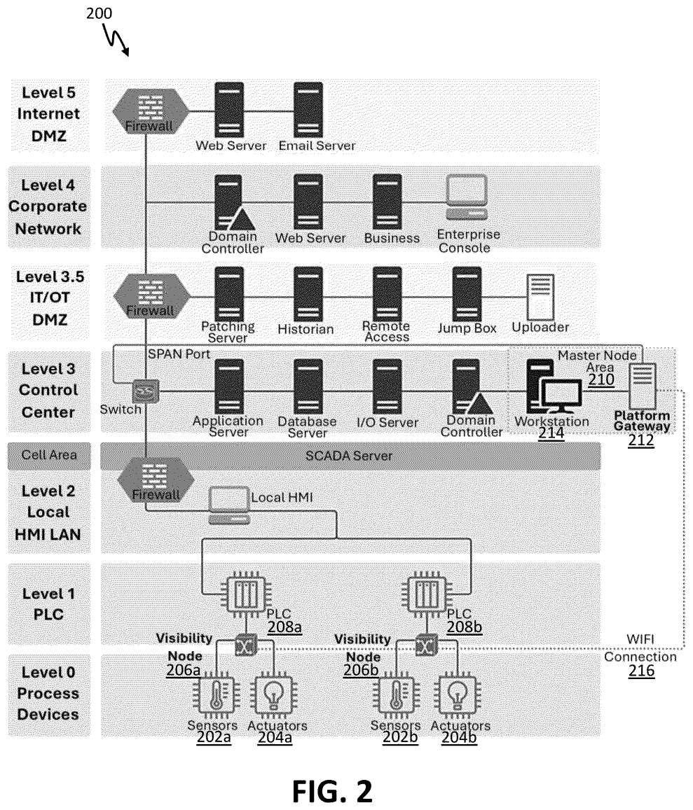

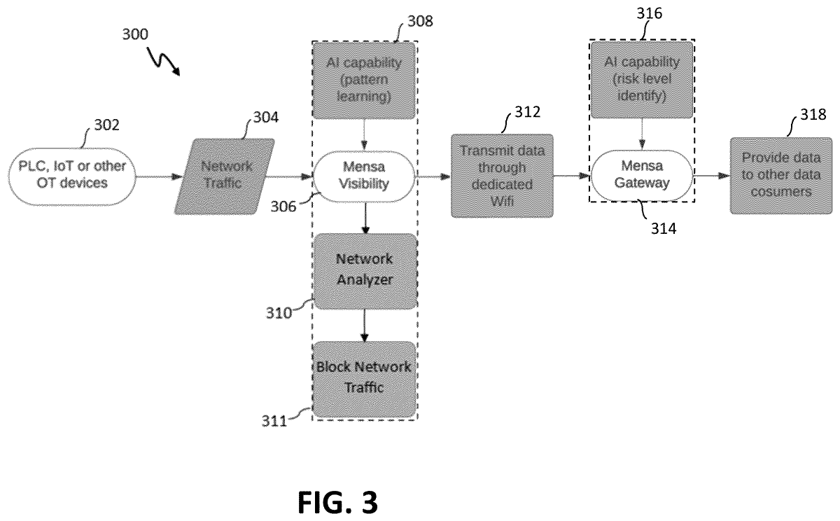

Accordingly, it should be appreciated that components of security monitor platform 104 can be implemented as, for example application containers or micro virtual machines that can run code for different types of applications. In one example, micro virtual machines' use cases can be implemented on gateway node 114 hosted in a public cloud platform (e.g. VPC in AWS). In another example, gateway node 114 can also be hosted on-premises locally in a dedicated physical host or run as a service on an engineering workstation (as shown in FIGS. 2-3, e.g. master node area).

Further, the implementations described herein with respect to application containers can be changed to non-containerized applications, for example, that are directly deployed on a virtual or physical infrastructure. In one example, instead of running multiple application containers, the security capabilities can be packaged as separate non-containerized apps running on the same host.

With continued reference to FIG. 1, security monitor system 100 can further optionally comprise a data store 128, such as a database, logical disk space, file, or other suitable storage medium configured to store libraries that support different protocols used by PLCs. In an embodiment of a database, data store 128 can be a general-purpose database management storage system (DBMS) or relational DBMS as implemented by, for example, ORACLE, IBM DB2, Microsoft SQL Server, PostgreSQL, MySQL, SQLite, LINUX, or UNIX solutions.

In an embodiment, data store 128 can be integrated with security monitor platform 104. For example, a library (e.g., packet capture library) can be stored in memory 112. In embodiments, PCAP (Network Packet Capture), can be stored in visibility node 116 or relay node 120 memory to minimize I/O bottleneck. Using such libraries, pre-processed information can then be sent to the master/gateway node 114, where master/gateway node 114 has ample system resources to write the information to secondary storage.

Process device 108 generally comprises a sensor 130 and/or an actuator 132. Process device 108 can be one of a distributed network of industrial devices, each device having its own data capturing capabilities.

Security monitor platform 104 can actively or passively monitor communications of process device 108, for example, with PLC 106. Such data can be used to allow for network traffic inspection in an active IPS mode and a passive IDS mode with additional network detection and response (NDR) capabilities.

Reference will now be made in detail to several embodiments of modes, examples of which are illustrated in the accompanying figures. It is noted that wherever practicable similar or like reference numbers may be used in the figures and may indicate similar or like functionality.

Referring to FIG. 2, a system diagram of an inline mode MENSA system 200 deployment in an ICS environment is depicted, according to an embodiment. For example, system 200 is depicted as implemented on a Purdue Model ICS environment having Levels 0-5. For ease of illustration, only selective system components are labelled.

System 200 generally comprises sensor 202a, actuator 204a, sensor 202b, and actuator 204b in Level 0. In an embodiment, sensors 202 and actuators 204 comprise components configured for physical processes associated with the ICS. For example, sensor 202a can sense activity related to one or more physical processes and actuator 204a can control one or more aspects of the physical processes. In embodiments, sensors 202 and actuators 204 can be substantially similar to sensor 130 and actuator 132 in FIG. 1, respectively.

System 200 further comprises visibility node 206a, which is operably coupled to sensors 202a and actuators 204a, and visibility node 206b, which is operably coupled to sensors 202b and actuators 204b. In an embodiment, each visibility node 206 is configured with a managed network switch connecting respective Input/Output (I/O) Modules (e.g. to master node 210) and PLCs 208a, 208b. In embodiments, visibility nodes 206 can be substantially similar to visibility nodes 116 in FIG. 1. In particular, visibility nodes 206 are respectively configured to receive signals related to sensors 202 and actuators 404. Visibility nodes 206 can be positioned relatively between Level 0 and Level 1 such that all traffic passes through the switch (e.g. visibility node).

Accordingly, system 200 further comprises PLCs 208a, 208b configured to process data passed by its respective visibility node 206a, 206b for further ICS execution (e.g. by Level 2 via local human-to-machine interface (HMI), then Level 3, and so on). In embodiments, PLCs 208a, 208b can be substantially similar to PLCs 106 in FIG. 1. In embodiments, level 1 can include other control systems, such as RTUs.

As illustrated, system 200 can be implemented with two visibility nodes in level 1 and a gateway node (e.g. “Master Node”) in level 3. In some implementations, system 200 can be arranged according to using the existing non-vendor lock-in managed switches. In some implementations, system 200 can be arranged by adding a new managed switch to the network environment.

In an embodiment, system 200 further comprises master node 210 including platform gateway 212 and workstation 214. Visibility nodes 206a, 206b are connected to master node 210 via, for example, WiFi connection 216. Though depicted as “WiFi,” connection 216 can be wired or wireless. In an embodiment, WiFi connection 216 can be a dedicated connection in that the operable coupling of visibility nodes 206a, 206b to platform gateway 212 is the only connection hosted by WiFi connection 216 (no other devices are connected). Platform gateway 212 (e.g. “gateway node”) utilizes its application container to receive the pre-processed network packets sent from visibility node 206a and/or visibility node 206b. In embodiments, master node 210 can be substantially similar to gateway node 114 in FIG. 1.

Workstation 214 comprises a computing device operably coupled to platform gateway 212. In an embodiment, workstation 214 is configured to view and control the results of security determinations via visibility node 206 data. In embodiments, workstation 214 can be substantially similar to computing device 102.

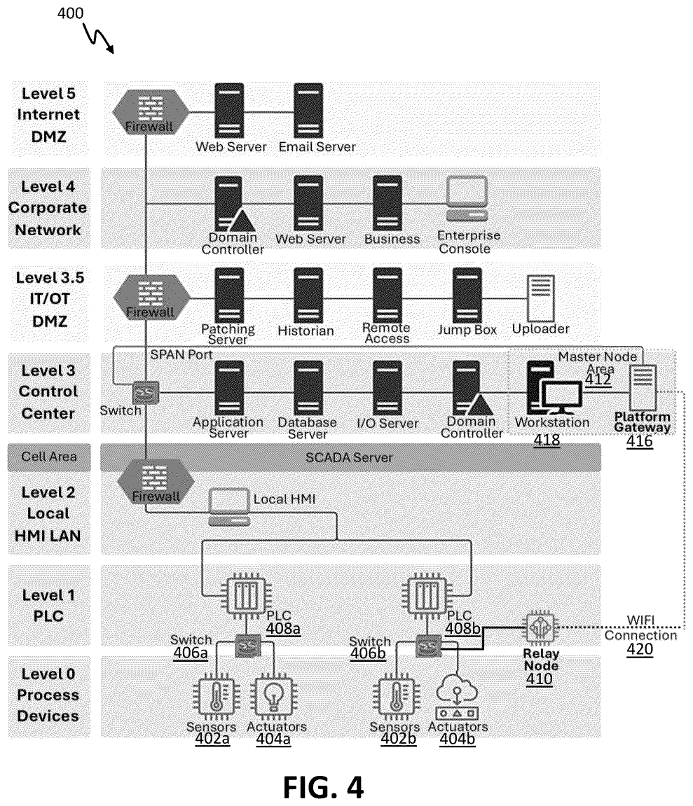

As shown in FIG. 2 (and as will be described in FIG. 4), a MENSA gateway is in the “Master Node Area.” The illustration describes a general conceptual deployment area for the MENSA gateway node. The MENSA gateway can be hosted on a separate, physical or virtual server, or one can host the gateway services as a service running on another host (such as an engineering workstation.)

Referring to FIG. 3, a process flow diagram of a method 300 of inline mode operation for a MENSA system is depicted, according to an embodiment. In an embodiment, method 300 can be implemented by system 100 as depicted in FIG. 1 or system 200 as depicted in FIG. 2. As described above, in an embodiment, and in combination with the other elements of systems 100/200, an inline mode system includes a gateway node (e.g. 210) and one or more visibility nodes (e.g. 206).

As will be described, inline mode relies on detection and blocking upon anomaly traffic inline for intrusion prevention. In one example, method 300 leverages an upgraded switch as a hybrid software defined networking appliance (e.g. visibility node 206). In embodiments, visibility nodes have deep packet inspection (DPI) capability so the visibility nodes can inspect the network packet anomaly, such as by packet sniffing (examining the content of data packets on the network). Once malicious payload is detected, the visibility node involved will send alerts to a user dashboard to determine whether the specific connection needs to be terminated. Reference will be made to systems 100 and 200 for ease of discussion.

At 302, programmable logical controllers, internet of things, and other operational technology devices (e.g. ICS, remote processing units (RPUs)) communicate via industrial communication protocols. For example, sensors 202 and/or actuators 204 can operate and generate communications intended for respective PLCs 208.

At 304, network traffic generated by devices connected to a visibility node flows through physical ports of the node. For example, referring to sensors 202a and actuators 204a, data of those process devices is flowed (communicated or intercepted) into visibility node 206a.

At 306, a visibility node (e.g. an industrial IoT device type such as visibility node 206a) processes both physical network traffic and software-defined network overlay to create a hybrid network security device. Through the management of a hybrid (physical and virtual) network, users can create an initial baseline connectivity pattern by first learning the initial pattern to start.

In an embodiment, two layers of detection and prevention capabilities include signature-matching and learning network patterns. For example, visibility node 206a can be initially configured with two signature-matching capabilities. In a first signature-matching capability, embodiments can detect malicious traffic and block the malicious traffic before the malicious traffic can exploit a vulnerability, such as an IPS. In a second signature-matching capability, embodiments can perform machine learning on a normal traffic pattern (as will be described further).

In addition to the aforementioned signatures, default network security policies can be generated based on learned patterns. After a pre-defined normalization period, users can then decide whether to select from specific modes.

In a detection mode, deviation(s) from learned connectivity patterns are allowed. Alerts are sent (e.g. to a user via workstation 214) to decide whether newly identified connectivity should be allowed.

In a prevention mode, deviation(s) from learned connectivity patterns are not permitted. Warnings are sent to the user (e.g. to a user via workstation 214) to notify whether abnormal connectivity has been attempted.

Accordingly, visibility nodes 206 have three modes—learning, detection, and prevention. The three modes allow for control of live inline network traffic with vetted connectivity patterns as security policies, thus achieving micro-segmentation capability as noted in a zero-trust architecture.

At 308, visibility nodes can optionally also implement AI capability modules to accelerate processing speed and enhance existing functionalities. In one aspect, visibility nodes 206 can implement machine learning (ML) algorithms to recognize connectivity patterns. ML performance can be further augmented by leveraging a neural processing unit (NPU) to accelerate the execution of machine learning/artificial intelligence.

In an embodiment, a pattern learning model can be trained using a training data set of normal device traffic. Accordingly, the pattern learning model can be utilized to form security policies using normal traffic. For example, a security policy can define normal traffic and accordingly one or more single deviations or levels of deviation (e.g. multiple instances of deviation) as abnormal.

At 310, a network analyzer captures network traffic, which includes packets with PLC protocol(s), decodes the PLC protocol, pre-processes to select packets, and packs the selected packet with a widely accepted protocol (i.e. HTTPS). The network analyzer captures network traffic by utilizing packet capture libraries (e.g., Pcap4J, JnetPcap, tshark) to directly intercept and collect packets from the network interfaces. Accordingly, the network analyzer can implement DPI. In embodiments, the network analyzer is containerized.

At 311, visibility nodes via network analyzer 310 can block network traffic (e.g., from being sent to a control system, such as a PLC). As illustrated in FIG. 3, AI capabilities at 308, network analyzer 310 sub-component, and network traffic blocking at 311 are capabilities of visibility nodes (e.g. 306/206). More particularly, visibility nodes can block anomaly traffic inline for intrusion prevention once network analyzer 310 has decoded one or more packets. In one aspect, detected potential malicious packets (such as those determined by the security policy) are blocked. For the packets that are not blocked, the visibility node will resend them to their original destination (e.g. only be the connected PLC in the ICS environment). Accordingly, visibility nodes can block network traffic (or resend non-malicious packets) in real-time. Here, real-time reflects the ICS ability to function normally with packet blocking and forwarding of the visibility node.

At 312, data in the widely accepted protocol is transmitted via dedicated connection, such as a WIFI channel. In other embodiments, the dedicated connection can be a physical network connection. For example, visibility node 206a sends pre-processed data to master area node 210 (e.g. “MENSA gateway”) through a dedicated wireless connection (e.g. WIFI connection 216).

At 314, the MENSA gateway, which is situated in Purdue model level 3, provides virtual network orchestration. For example, platform gateway 212 accepts incoming data over wireless connection 216 from visibility nodes 206, performs data analysis tasks, and serves as the API providing data upon request for third party software/devices, allowing selected system 200 data to be consumed as to enhance interoperability.

At 316, the MENSA gateway can optionally implement AI capability modules. For example, an AI module 126 can implement automated response based on security policies. In a first aspect, in a detection mode, master area node 210 can send alerts (e.g. to SecOps admins). In a prevention mode, master area node 210 can send alerts and block out-of-line connectivity patterns. In a second aspect, based on available system resources and hardware specifications, additional AI modules can be implemented to identify the risk level based on an analysis of streaming packets (e.g. NDR). For example, a ML model can be trained on various streaming packets and known risk levels. Based on an evaluated streamed packet, a given risk level can be identified and further communicated (e.g. via workstation 214). As illustrated in FIG. 3, AI capabilities at 316 are capabilities of the MENSA gateway (master area node 210/gateway 314).

At 318, data can be provided to other data consumers. In an embodiment, the MENSA gateway node can communicate and provide a data feed to other devices or databases. In one example, master area node 210 can provide data to third party data customers (i.e. such as in a data correlation and aggregation engine in fulfillment to cyber asset attack surface management capability).

Accordingly, in a visibility node embodiment such as FIGS. 2-3, visibility nodes are configured to perform blocking of determined malicious network traffic and the gateway node is configured to perform risk determination related to the network traffic.

Referring to FIG. 4, a system diagram of an offline mode MENSA system 400 deployment in the ICS environment is depicted, according to an embodiment. For example, system 400 is depicted as implemented on a Purdue Model ICS environment having Levels 0-5. For ease of illustration, only selective system components are labelled.

System 400 generally comprises sensor 402a, actuator 404a, sensor 402b, and actuator 404b in Level 0. Sensors 402 and actuators 404 can be substantially similar to sensors 202 and actuators 204 described in FIG. 2.

System 400 further comprises switch 406a which is operably coupled to sensors 402a and actuators 404a, and switch 406b, which is operably coupled to sensors 402b and actuators 404b. In an embodiment, switches 406 are configured with a SPAN port function. In particular, switches 406 are respectively configured to receive signals related to sensors 402 and actuators 404.

System 400 further comprises relay node 410, which is also operably coupled to switch 406a and switch 406b (though only the connection to switch 406b is depicted in FIG. 4 for ease of illustration). In an embodiment, relay node 410 is an IIoT device that relays data from switches 406 to master node 412. Relay node 410 can be substantially similar to relay node 120 in FIG. 1. In one example, relay node 410 is configured to capture, decode, and pre-process network traffic from switches 406.

In particular, system 400 leverages an industrial IoT device (connects to a switch's SPAN feature (aka mirror) port, which creates a copy of network traffic (e.g. IIoT device relay node 410). Relay node 410 includes a containerized network analyzer application which decodes the mirrored traffic. Relay node can perform a simple pre-processing to summarize the network activity and protocols. Relay node 410 then sends alerts to a user dashboard (e.g. workstation 418) to allow determinations as to whether the specific connection needs to be terminated.

Master node 412 is substantially similar to master node 210. Further, platform gateway 416 can be substantially similar to platform gateway 212, and workstation 418 can be substantially similar to workstation 214.

As illustrated, system 400 can be implemented with an IIoT device (e.g. 410), a switch with a SPAN feature (e.g. 406), and a gateway node (e.g. 412) in level 3. In some implementations, system 400 can be configured to use the SPAN port function in existing switches.

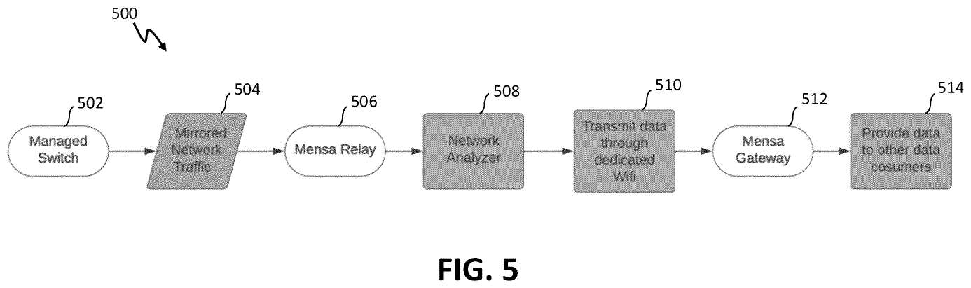

Referring to FIG. 5, a process flow diagram of a method 500 of offline mode operation for a MENSA system is depicted, according to an embodiment. In an embodiment, method 500 can be implemented by system 100 as depicted in FIG. 1 or system 400 as depicted in FIG. 4. As described above, in an embodiment, and in combination with the other elements of systems 100/400, an offline mode system includes a gateway node, one or more switches with the SPAN feature, and a relay node connecting to each switch. As will be described, method 500 implements intrusion detection, which does not block real-time traffic (in contrast to intrusion prevention in FIGS. 2-3).

Reference will be made to system 400 for ease of discussion. With further reference to the switch(es) in system 400, switch 406a, 406b are managed network switches, which respectively implement network technology (e.g. hardware and/or virtualized) that allow Ethernet devices to communicate with each other and that contains features to configure, manage, and monitor traffic on a Local Area Network (LAN). In an embodiment, managed switches 406a, 406b include a mirroring port, which is a dedicated port on a network switch.

At 502, the managed network switch receives a copy of all network packets seen on one or more specified ports (called source ports). For example, switch 406a receives a copy of all source ports of sensors 402a and actuators 404a.

At 504, mirrored network traffic is captured. For example, by leveraging an existing managed switch's functionality at 502, data traffic connecting to the network switch (e.g. 406a) is replicated and sent forth to MENSA relay node (e.g. relay node 410).

At 506, the MENSA relay node, in one aspect, an industrial IoT device, processes both replicated physical network traffic and software-defined network overlay to create a hybrid network security device. Through the management of a hybrid (physical and virtual) network, users can create initial baseline connectivity patterns by first learning the initial pattern to start.

Similar to the MENSA visibility node described above, relay nodes can implement two primary functionalities: signature-matching for abnormalities and machine-learning of network connectivity patterns. In one aspect, a relay node is pre-configured with a signature-matching capability to detect malicious traffic like an IDS.

In an embodiment, default network security policies are generated based on learned patterns. After a pre-defined normalization period, users can then decide whether to advance into one specific mode. A detection mode in which deviation(s) from learned connectivity patterns are allowed. Alerts are sent to the user to warn about the newly identified out-of-bound connectivity.

At 508, a network analyzer captures network traffic, which includes packets with PLC protocol(s), decodes the PLC protocol, pre-processes to select packets, and packs the selected packet with a widely accepted protocol (i.e. HTTPS).

At 510, data is transmitted through a dedicated connection. The MENSA relay node sends pre-processed data flow to the MENSA gateway (e.g. master area node 412) through a dedicated connection, such as WiFi connection 420. Though depicted as “WiFi,” connection 216 can be wired or wireless. In an embodiment, WiFi connection 420 can be a dedicated connection in that the operable coupling of visibility nodes relay node 410 to platform gateway 416 is the only connection hosted by WiFi connection 420 (no other devices are connected).

In embodiments, a distinction between inline mode operation and offline mode operation is the pre-processing of the packets. In offline mode because the relay node is connected to the SPAN port and receives a clone of the original packets, the cloned packets do not need to be resent to the original destination (e.g., the PLC). Therefore, the relay node does not need to send cloned packets to the PLC even if the cloned packets are known to be non-malicious. Regardless, the selected packets are still repacked (e.g., into HTML) and sent to the gateway for further analysis.

Similar to 314 in FIG. 3, at 512, the MENSA gateway can provide virtual network orchestration. For example, platform gateway 416 accepts incoming data over wireless connection 420 from visibility nodes relay node 410, performs data analysis tasks, and serves as the API providing data upon request for third party software/devices, allowing selected system 400 data to be consumed as to enhance interoperability. Similar to 318 in FIG. 3, at 514, data can be provided to other data consumers.

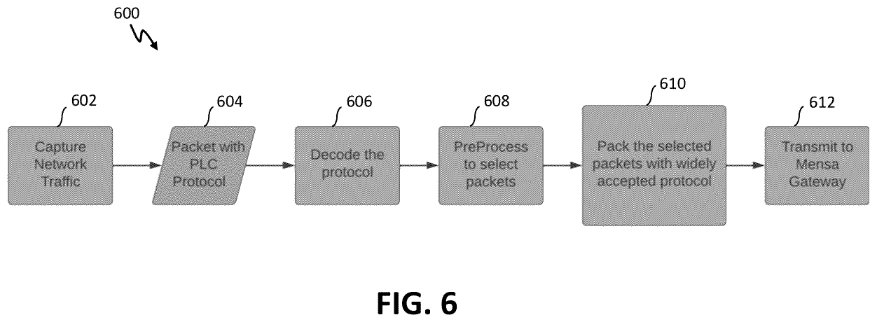

Referring to FIG. 6, a process flow diagram of a method 600 of network analyzer operation for a MENSA system is depicted, according to an embodiment. In an embodiment, method 600 can be implemented by system 100 as depicted in FIG. 1 or components of systems 200/400 as depicted in FIGS. 2 and 4. More particularly, a network analyzer can be implemented on visibility node 206 and relay node 410, respectively.

At 602, a network analyzer can capture network traffic, including a packet with a PLC protocol at 604. In an embodiment, a network analyzer can be operably connected to an industrial control device (e.g. physical or wireless connection). In another embodiment, a network analyzer can be positioned along a network path of an industrial control device to as to “see” network communication (604) of the device. At 606, the network analyzer can decode the PLC protocol, such as by using a library of PLC supported protocols stored on the network analyzer hardware itself, or by retrieval from a device or storage external to the network analyzer. At 608, the network analyzer can pre-process the packet(s) to determine select packets of the network communication (604) stream or series of communications. For example, at 608, the packets can be reviewed for metadata header and certain payload data (e.g. by certain size) to filter those packets without the required header and/or size. At 610, the selected packets are re-packed in a different protocol (e.g. widely accepted protocol). In one aspect, the widely accepted protocol is a secure protocol, such as HTTPS. In one aspect, the widely accepted protocol is not secure, such as HTTP. At 612, the re-packed selected packets are transmitted to the MENSA gateway.

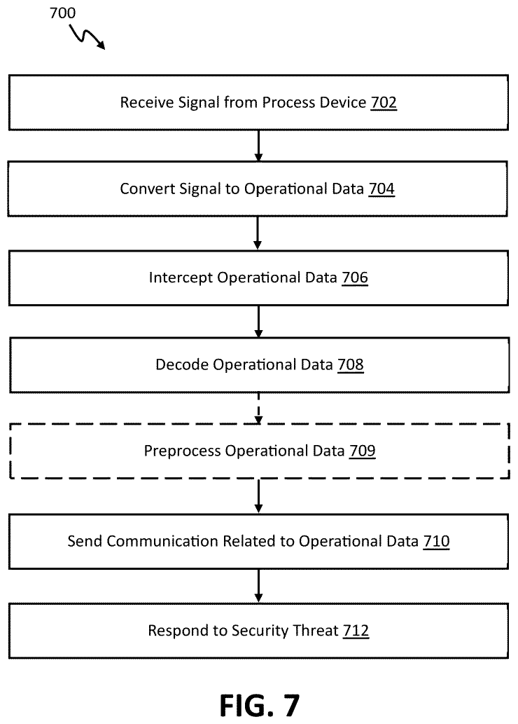

Referring to FIG. 7, a flowchart of a method 700 for monitoring low-level network communications of an industrial control environment is depicted, according to an embodiment. In an embodiment, method 700 can be implemented by system 100 as depicted in FIG. 1 or components of systems 200/400 as depicted in FIGS. 2 and 4. Reference is made herein further with respect to system 100.

At 702, method 700 comprises receiving a signal from a process device. For example, input/output module 124 can receive a signal from sensor 130 and/or actuator 132.

At 704, method 700 further comprises converting the received signal from 702 to operational data. For example, at least one of visibility node 116 or relay node 120 (depending on the mode) can convert the signal into operational data that can be processed by programmable logic controller (PLC) 106.

At 706, method 700 further comprises intercepting operational data. For example, in an inline mode, visibility node 116a can intercept the operational data at switch 118a. In another example, in an offline mode, relay node 120a can intercept (e.g. via mirroring or cloned traffic) data at a switch (e.g. 406a, with reference to FIG. 4).

In embodiments, because the visibility node or relay node is situated between the process devices (e.g., OT devices) communicating with the PLC, the network analyzer can intercept the packets (e.g., network traffic) that are sent. In the ICS environment, the packets between the OT devices and PLC are mainly using PLC protocols.

At 708, method 700 further comprises decoding operational data. For example, visibility node 116 can perform packet inspection for any network packet anomaly or anomaly in the data itself. In another example, relay node 120 can decode the network traffic including performing preprocessing on the operational data, summarize the network activity and protocols, and detect a threat in the data.

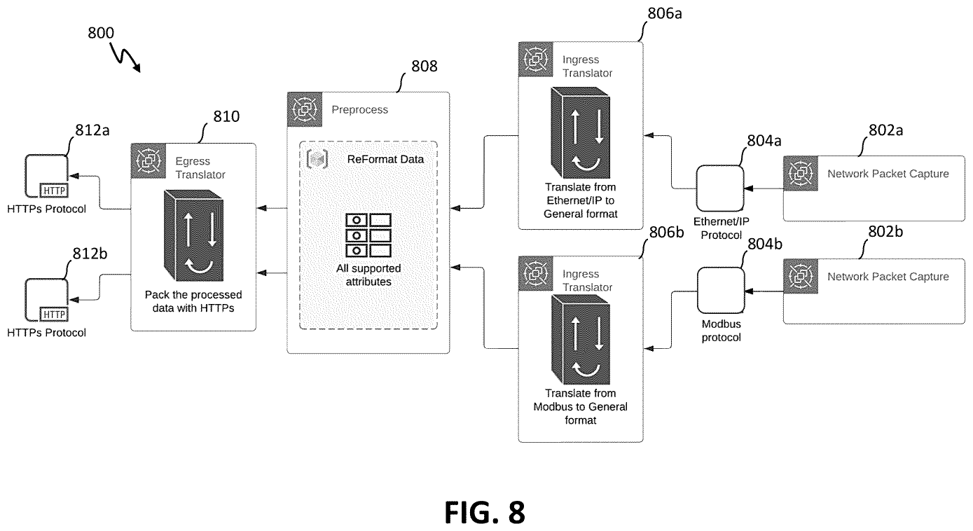

In embodiments, a network analyzer can decode the protocol. A packet capturer (e.g. Pcap4J) of the network analyzer can use a passer to identify the supported protocol of the captured traffic. The supported protocols can, for example, be one of the protocols used by most of the widely used PLCs (e.g. S7 protocol for Simens, Ethernet/IP for Allen-Bradley, etc.) The passer can (e.g., then) use the PLC protocol library to decode the captured traffic (e.g. the Modbus analyzer, the S7 comm dissector). Referring further to FIG. 8, a method 800 for capturing and decoding operational data is depicted, according to an embodiment. Method 800 can be implemented by a network analyzer on, for example, a visibility node or a relay node. In embodiments, method 800 can be performed by a protocol translator of the network analyzer.

At 802, the network analyzer captures network packets. In one case, at 802a, a network packet is captured, for example, based on an Ethernet/IP protocol 804a functionality. In another case, at 802b, a network packet is captured, for example, based on a Modbus protocol.

At 804, a protocol translator can fetch the header/meta data of stream traffic (i.e. in the PLC protocol format). For example, in the IPS mode, the network packet capturer can intercept the passing packets (such as in S7, Modbus, Ethernet/IP, Profinet protocols used in the communication between PLC and OT/IoT devices).

In embodiments, a protocol translator at the network analyzer can be used to detect and decode a wide array of PLC protocols. This functionality is distinct from conventional network analysis that generally supports only the widely used high level protocols (e.g., which cannot be used to decode and detect the PLC protocols).

At 806, the ingress translator can use the corresponding protocol decode libraries to read each attribute in the protocol of each analyzed packet. For example, for the Modbus protocol case, the attributes include Transaction Identifier, Protocol Identifier, Length, Unit Identifier, Function Code, and Data. At 806a, ingress translation translates Ethernet/IP packet to a general format. At 806b, ingress translation translates Modbus packets to a general format. In an embodiment, the translation at 806b can be to the same format as 806a. In another embodiment, the translation at 806b can be to a different format as 806a.

At 808, a preprocessing can reformat data from 806a and 806b. For example, data can be reformatted using the attributes that can be identified and accordingly selected and formatted. Preprocessing rules can be defined based on one or more of: an AI learned pattern (e.g., learning mode); a pre-defined signature (e.g., snort); self-defined policies (e.g., block traffic with specific tag, such as Cisco TrustSec).

In embodiments the data translated at 806 can be fetched out and stored in as ReFormat Data during the preprocessing at 808.

At 810, The network analyzer can determine whether the decoded packet is malicious based on the attributes of the decoded packet. If the packet is determined to be malicious, the decoded packet can be packed into HTTPs and sent to the gateway node for further analysis. Egress translation packs the (pre)processed data with HTTPS, and forwards the packed data using HTTPS protocol. For example, data from the 802a stream is sent as 812a, and data from the 802b stream is sent as 812b.

With continued reference to FIG. 7, at 709, method 700 optionally further comprises preprocessing operational data (e.g., as discussed with respect to FIG. 8). More particularly, in an IPS mode, a visibility node can, in pre-processing the operational data, determine packets to be blocked or not (e.g. by itself). For the packets that are potentially malicious (e.g. but not totally confident on the determination by visibility node), visibility node can release (resend to its original destination) the intercepted traffic and send the decoded packet to the gateway. In an embodiment, a configurable restriction on the processing time of the packets allows for the prevention of delays before resending. In one aspect, eliminating delays that would affect the underlying system allows for real-time operation.

At 710, method 700 further comprises sending a communication related to the operational data. For example, visibility node 116 can communicate a threat in the operational data to computing device 120. In another example, relay node 120 can communicate a threat in the operational data to computing device 102.

In embodiments at 710, a worker node can pack the selected packet with a widely accepted protocol (e.g., HTTPs as shown in FIG. 8). Due to the restrictions of many third-party security platforms, repackaging to a more widely used high-level protocol may be necessary. For example, the communication at 710 can be the pre-processed data from 709 (e.g. from a visibility node). In another example, the communication at 710 can be the data captured by mirroring (e.g. from a relay node).

At 712, method 700 further comprises responding to the security threat. For example, computing device 102 can prompt an alert to a user dashboard for a determination of whether a specific connection needs to be terminated, such as process device 108. In another example, computing device 102 can automatically terminate the connection.

Method 700 accordingly provides for security threat and response in operational technology systems.

In an example scenario when implementing method 700, a visibility node can detect potential risk packets and send the potential risk packets to the gateway node (e.g., for further analysis). The visibility node can detect high risk packets at 708. At 710, the visibility node can respond according to its security mode.

In the IPS mode, the detected potential malicious packets will be blocked. For the packets that are not selected, the visibility node will resend them to their original destination (e.g., the connected PLC in ICS environment).

In the IDS mode, the packets will not be intercepted. The network analyzer can make a copy of the packets, do the preprocessing (e.g., fetch the header info of the detected high-risk packets), repack, and send the potential malicious packets to the gateway node for analysis. The non-malicious packets can be dropped since they are just a copy of previously sent network traffic.

At 712, a security preventative or corrective security action can be taken.

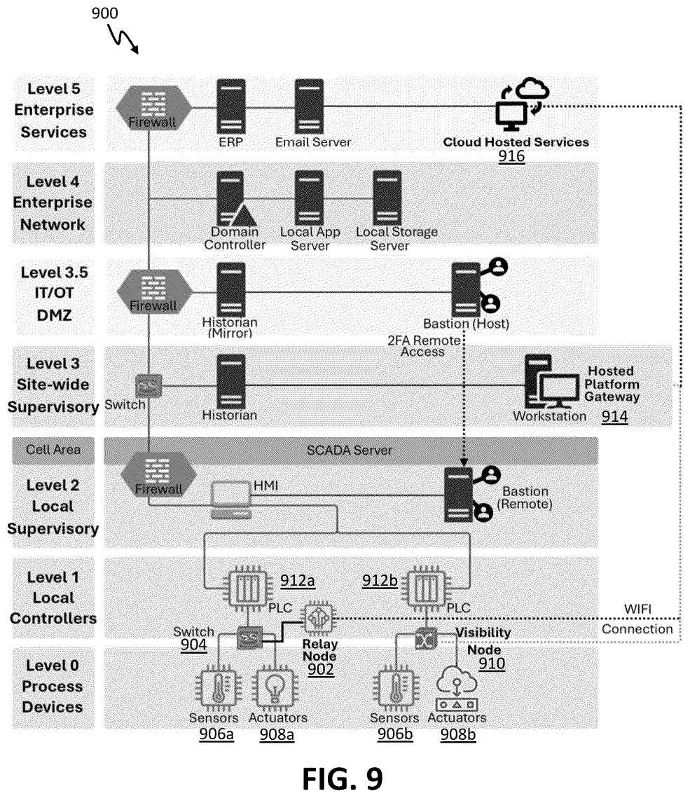

Referring to FIG. 9, a system diagram of a mixed mode MENSA system 900 deployment in an ICS environment is depicted, according to an embodiment. For example, system 900 is depicted as implemented on a Purdue Model ICS environment having Levels 0-5.

The mixed mode of operation leverages one or more relay nodes of the offline mode and one or more visibility nodes of the inline mode. The use of each operational mode can allow for increased implementation flexibility, resource management, and scalability based on the needs and process device of the ICS environment. The security monitor system can deploy IPS and/or IDS techniques within a single system or process that uses mixed mode operation.

The incorporation of a relay node 902 within system 900 can be appropriate in scenarios where the process device network traffic is particularly sensitive as relay node 902 can rely on the SPAN functionality of an existing switch 904 and may therefore be unable to manipulate device traffic originating from sensors 906a and actuators 908a (e.g., process devices). For example, if relay node 902 became corrupt, for example from a malware attack, the partial implementation of an offline mode can limit the potential attack surface area within the ICS system (e.g., because relay node 902 cannot manipulate network traffic reaching the upstream PLC 912a. Implementations using relay nodes 902 can be cost effective as existing switches are relied upon, allowing the relay node to operate without the inclusion of an internal switch.

The incorporation of a visibility node 910 within system 900 can be appropriate in scenarios where IPS techniques are desired as viability node 910 can manipulate device traffic originating from sensor 906b and actuators 908b. For example, if sensor 906b becomes corrupt, visibility node 910 can prevent unwanted traffic from reaching the upstream PLC 912b.

Regardless of the type of node used for particular process devices, the decoded network traffic can be sent from the worker node to the gateway node 914, cloud hosted services 916, and/or a dedicated security monitoring database (not shown). As illustrated, gateway node 914 can be implemented on a dedicated host, such as a workstation.

Cloud hosted services 916 can be services that are, for example, based on the low-level security monitoring. For example, an operation center can remotely monitor network traffic for anomalous events via cloud hosted services 916.

A security monitoring database can be used to log monitored traffic, detected security events, taken security actions, and the like. For example, the security monitoring database can include a library of PLC supported protocols. In some implementations the security monitoring database can operate at Level 3.

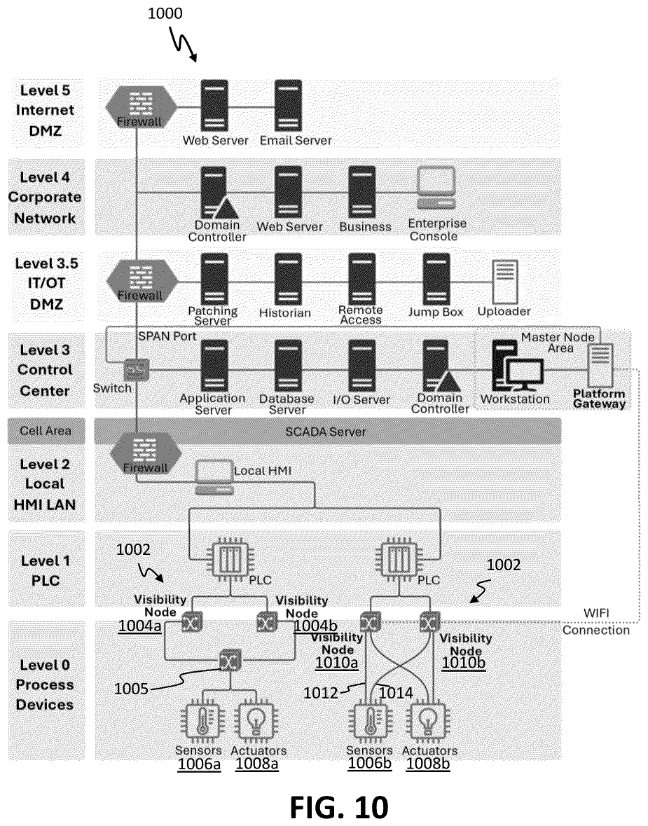

Referring to FIG. 10, a system diagram of an inline mode MENSA system 1000 deployment with redundancy in an ICS environment is depicted, according to an embodiment. For example, system 1000 is depicted as implemented on a Purdue Model ICS environment having Levels 0-5. For ease of illustration, only selective system components are labelled.

A first redundance 1002 implements two visibility nodes 1004a, 1004b to avoid the block of all traffic from sensors 1006a and actuators 1008a via switch 1005 due to the single point failure on a visibility node in single node deployment. For example, both visibility node 1004a and visibility node 1004b can process data from sensors 1006a. And, both visibility node 1004a and visibility node 1004b can process data from actuators 1008a.

A second redundance 1004 implements two visibility nodes directly connected to the OT devices sensors 1006b and actuators 1008b, with two different channels of communication 1010 and 1012. In FIG. 10, communication channel 1012 from sensors 1006b to visibility node 1010a and communication channel 1014 from sensors 1006b to visibility node 1010b are labelled (and other corresponding channels from actuators 1008b respectively to visibility node 1010a and visibility node 1010b are not, for ease of illustration). In this case, OT devices 1006b, 1008b must have the capability of switching to and from another channel when failure occurs on one of visibility node 1010a or 1010b. For example, when visibility node 1010a fails, sensors 1006b can detect a failure of visibility node 1010a via channel 1012 and switch its communication to channel 1014. This can avoid all single point failure between the PLC and OT devices.

Mission-critical use cases, such applying real-time network security to an aerial unmanned vehicle, more commonly known as a drone, require a fault-tolerant security solution. Redundant security monitoring methods, such as method 900, represent an enhanced implementation of low-level security monitoring to resolve this challenge.

The highly available MENSA deployment can be implemented as physical and virtualized nodes. For example, two virtualized industrial IoT devices can be built on a physical industrial IoT (e.g., if system resources are allowed). The high availability is achieved via distribution of the application workload, such that there is a higher-level of dependency on the orchestration platform coordinating connected network traffic between cyber and physical networks.

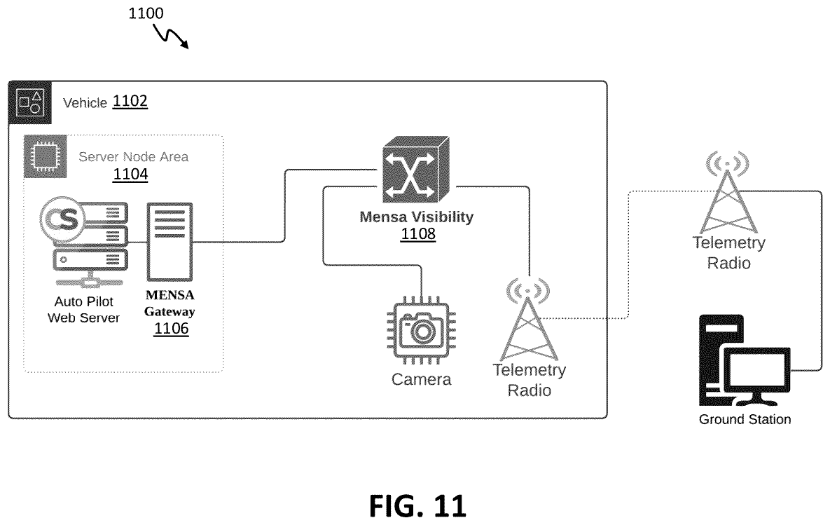

Referring to FIG. 11, a system diagram of a highly available MENSA system deployment 1100 is depicted, according to an embodiment.

In embodiments, vehicle 1102 can be an unmanned arial vehicle (UAV).

In the server node area 1104, a MENSA gateway 1106 can be hosted as an auxiliary service (e.g., an application) on flight management systems. MENSA gateway 1106 can manage and maintain the security policies to be enforced by the MENSA visibility node(s) 1108.

In embodiments, vehicle 1102 can first baseline the normal connectivity pattern to create the initial security policies for normal/allowed traffic. After a machine learning time is completed, vehicle 1102 can enter prevention mode, enforcing a safe mode mechanism. If an abnormal connectivity attempt is detected, the safe mode will block any attempt to change from the locked down connectivity pattern. Since the visibility node can implement a signature-matching capability as an IPS, any malicious traffic coming in via vetted connectivity channels will still be detected. Security alerts can be sent to designated automated remediation mechanism following a pre-defined response procedure.

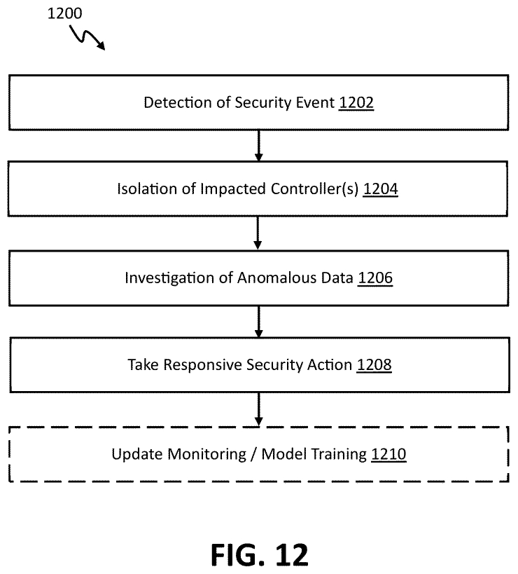

Referring to FIG. 12, an example use case of a method 1200 for security monitoring is depicted, according to an embodiment. Method 1200 can be used to realize the aforementioned benefits of embodiments, such as the systems and methods of the aforementioned figures.

At 1202, a security event is detected. Detection of a security event can be based on, for example, detection of an unusual increase in signaling from a process device.

At 1204, relevant devices and/or control systems can be isolated. For example, the process device and a PLC receiving the signals can be isolated from the network to prevent potential spread of malware. Improved low-level security visibility allows for this isolation to occur at Level 0. In conventional security monitoring systems, implementation of isolation and/or security actions is limited to monitoring network traffic coming from the control system (e.g., PLC)—rather than process data being sent to the control system.

At 1206, an investigation can be performed. For example, logs and process device data, such as operational parameters, can be analyzed, potentially revealing unauthorized commands being sent to the PLC. The investigation can be automatic based on monitoring for patterns of malicious activity associated with security profiles.

At 1208, a security action can be taken in response to the investigation. For example, the process device can be decommissioned until maintenance can be performed, the network connection used by the process device can be shut down, access credentials for the compromised PLC can be revoked, and firmware updates can be applied to patch vulnerabilities.

Optionally at 1210, monitoring capabilities of the security monitoring system can be refined based on the performed investigation and security action(s) taken. For example, a machine learning model can be trained to recognize similar threats in the future or to recommend particular actions based on the responsive security action taken at 1208.

In some implementations, increased monitoring is implemented for involved process devices and/or control systems to ensure reduced or no further malicious activity. Increased monitoring can be applied systematically based on the function, type, or versioning of devices involved in the security event.

In embodiments, a report can be prepared on the incident, such as refinements made to security handling parameters.

Low-level security visibility in ICS environments allows detailed insights into the operations and potential security threats at the foundational layers of the control system. This enhanced visibility, for example into behavior of process devices, allows for the early detection of anomalies, quicker response to incidents, and more effective mitigation of risks.

In some implementations, process devices are manufactured and maintained by third-parties, inhibiting the ability of an organization to effectively police secure operation of these devices at a fundamental level. For example, as security threats evolve, organizations are often forced to rely on the capabilities of the manufacturer to release sufficient software updates.

Benefits of low-level security visibility in ICS include proactive detection of anomalies, detailed forensics, situational awareness, proactive maintenance, and minimized impact area from attacks. Low-level security visibility and corresponding security actions are important in maintaining the integrity and availability of ICS systems.

The figures and foregoing description relate to embodiments by way of illustration only. It should be noted that from the foregoing discussion, alternative embodiments of the structures, systems, and methods disclosed herein will be readily recognized as viable alternatives that may be employed without departing from the principles of what is claimed.

1. A security monitoring system for monitoring low-level network communications of an industrial control environment, comprising:
an input/output module configured to:
receive a signal from a process device associated with the industrial control environment,
convert the signal into operational data that can be processed by a programmable logic controller (PLC); and
a worker node configured to:
intercept the operational data using a switch,
decode the operational data based on a library of PLC supported protocols, and
send the decoded operational data over a wireless network interface; and
a gateway node configured to:
receive the decoded operational data via the wireless network interface, and
respond to a security threat in the decoded operational data.

2. The security monitoring system of claim 1, wherein the worker node includes the switch.

3. The security monitoring system of claim 1, wherein the switch has a switched port analyzer (SPAN) feature and the worker node includes an Internet of Things (IoT) device configured to communicatively connect to the switch via a SPAN port.

4. The security monitoring system of claim 3, wherein the worker node being configured to intercept the operation data comprises the IoT device collecting a copy of the operational data via the SPAN port.

5. The security monitoring system of claim 1, wherein the security monitoring system is implemented as an application container group, and wherein the gateway node includes an application container of the application container group.

6. The security monitoring system of claim 5, wherein the worker node includes the switch and a second application container of the application container group, and wherein the operational data is intercepted and decoded by a containerized network analyzer of the second application container.

7. The security monitoring system of claim 5, wherein the switch has a switched port analyzer (SPAN) feature and the worker node includes an Internet of Things (IoT) device including a second application container of the application container group, and wherein the operational data is intercepted and decoded by a containerized network analyzer of the second application container.

8. The security monitoring system of claim 5, wherein the application container group is isolated using system-level virtualization.

9. The security monitoring system of claim 1, wherein the security monitoring system is implemented as a virtual machine, and wherein the gateway node is hosted on a public cloud platform.

10. The security monitoring system of claim 1, wherein the worker node is further configured to, after decoding the operational data:
pre-process the operational data to select certain operational data packets; and
pack the selected certain operational data packets into a transfer protocol, the transfer protocol being different than a protocol of the operational data.

11. The security monitoring system of claim 1, wherein the worker node is further configured to detect a traffic pattern within the operational data based on an AI machine learning (ML) model trained on traffic pattern data.

12. The security monitoring system of claim 1, wherein the gateway node is further configured to identify a risk level a pattern within the decoded operational data based on an AI machine learning (ML) model trained on streaming packet data.

13. The security monitoring system of claim 1, further comprising a second worker node coupled to the process device, wherein the worker node and the second worker node are configured to process the process device data including intercepting the operational data, decoding the operational data, and sending the decoded operational data.

14. A method for monitoring low-level network communications of an industrial control environment, comprising:
receiving a signal from a process device associated with the industrial control environment;
converting the signal into operational data that can be processed by a programmable logic controller (PLC);
intercepting the operational data using a switch;
decoding the operational data based on a library of PLC supported protocols; and
sending the decoded operational data over a wireless network interface; and
responding to a security threat in the decoded operational data.

15. The method of claim 14, wherein the intercepting and decoding the operational data is performed by a worker node that includes the switch.

16. The method of claim 15, wherein the worker node includes an application container, and wherein the operational data is intercepted and decoded by a containerized network analyzer of the application container.

17. The method of claim 14, wherein the switch has a switched port analyzer (SPAN) feature and intercepting the operational data is performed by a worker node that includes an Internet of Things (IoT) device configured to communicatively connect to the switch via a SPAN port.

18. The method of claim 17, wherein the worker node being configured to intercept the operation data comprises the IoT device collecting a copy of the operational data via the SPAN port.

19. The method of claim 18, wherein the Internet of Things (IoT) device includes an application container, and wherein the operational data is intercepted and decoded by a containerized network analyzer of the application container.

20. A system for monitoring low-level network communications of an industrial control environment, comprising:
at least one visibility node or relay node positioned on a communication channel between a process device and a control system, configured to:
capture a stream of control system packets from the process device,
decode the control system packets,
preprocess the decoded control system packets to determine a subset of the decoded control system packets, and
pack the subset of the decoded control system packets into a transfer protocol, the transfer protocol being different than a protocol of the stream of control system.
